(19) United States
(12) Patent Application Publication
(10) Pub. No.: US 2026/0140808 A1
(43) Pub. Date: May 21, 2026

(54) SEQUENTIAL LOGGING OF SIGNALS IN A COMMUNICATION FABRIC

(71) Applicant: International Business Machines Corporation, Armonk, NY (US)

(72) Inventors: Seamus J. Burke, Tucson, AZ (US); Todd C. Sorenson, Tucson, AZ (US); Louis A. Rasor, Tucson, AZ (US)

(21) Appl. No.: 18/951,974

(22) Filed: Nov. 19, 2024

(51) Int. Cl. G06F 11/07; G06F 13/42

(52) U.S. Cl. CPC G06F 11/0772; G06F 13/4221; G06F 2213/0026

(57) ABSTRACT

A computer-implemented method includes receiving signal data within a communication fabric; generating at least one sequential log corresponding to at least a portion of the signal data; determining one or more automated actions to be carried out in connection with one or more endpoint devices within the communication fabric based at least in part on the at least one sequential log; and transmitting the at least one sequential log and information pertaining to the one or more automated actions to at least one of one or more nodes within the communication fabric and at least one of the one or more endpoint devices within the communication fabric.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The present application generally relates to information technology, and to error signal processing. However, conventional approaches commonly create inaccurate signal records which can lead to system latencies, outages, etc.

### SUMMARY

In at least one embodiment, an example computer-implemented method can include receiving signal data within a communication fabric, and generating at least one sequential log corresponding to at least a portion of the signal data. The method can also include determining one or more automated actions to be carried out in connection with one or more endpoint devices within the communication fabric based at least in part on the at least one sequential log. Further, the method can additionally include transmitting the at least one sequential log and information pertaining to the one or more automated actions to at least one of one or more nodes within the communication fabric and at least one of the one or more endpoint devices within the communication fabric.

Another embodiment of the invention or elements thereof can be implemented in the form of a computer program product tangibly embodying computer readable instructions which, when implemented, cause a computer to carry out a plurality of method steps, as described herein. Furthermore, another embodiment of the invention or elements thereof can be implemented in the form of a system including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating example system architecture for sequential logging of signals in a communication fabric, according to an example embodiment of the invention;

FIG. 2 shows pseudocode for example sequential logs in an illustrative embodiment;

FIG. 3 is a flow diagram illustrating techniques according to an example embodiment of the invention; and

FIG. 4 is a diagram illustrating a computing environment in which at least one embodiment of the invention can be implemented.

### DETAILED DESCRIPTION

As described herein, at least one embodiment includes sequential logging of peripheral component interconnect express (PCIe) fabric errors for fault isolation and recovery. As noted above and further detailed herein, PCIe error signaling can include, for example, an endpoint detecting an error and sending an error signal to a root complex. The root complex can then stop all current inbound and outbound traffic until the root complex is placed back into a normal state. During that time, with all inbound and outbound traffic being stopped, additional error signals may be unsuccessfully attempted to be sent by one or more endpoints. When the root complex is re-enabled (i.e., placed back into a normal state), and error status registers are examined, one or more error signals may be present, and it is not possible, under conventional approaches, to determine which of the error signals was sent first.

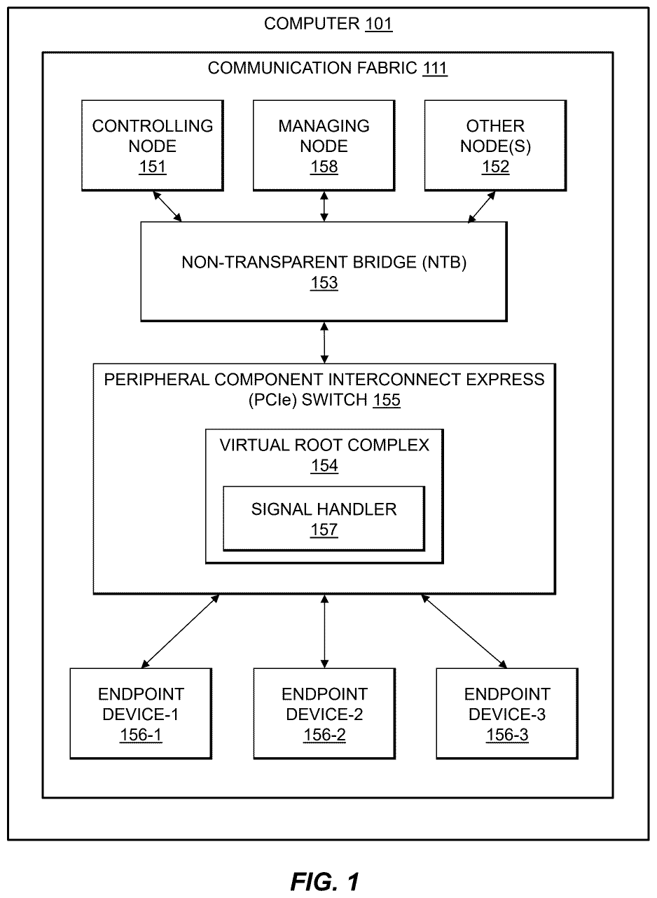

Accordingly, one or more embodiments includes keeping track of all incoming signals and logging the corresponding details in at least one sequential log, which can then be processed in connection with discovering a true sequence of events and used for fault isolation and/or one or more recovery operations. As further detailed herein (e.g., in connection with FIG. 1), such an embodiment includes implementing at least one programmable virtual root complex that resides in a switch within the given system. When error signals are received and/or processed by such a virtual root complex, at least one sequential log of the error signal types and corresponding details will be generated and stored for further processing. Further, in one or more embodiments, at least one managing node, in communication with the virtual root complex, can query for the sequential log and determine, based at least in part on processing the sequential log, the order in which the errors occurred (e.g., to determine a first error that caused one or more system issues).

FIG. 1 is a diagram illustrating example system architecture for sequential logging of signals in a communication fabric, according to an example embodiment of the invention. By way of illustration, FIG. 1 depicts a communication fabric 111 of computer 101. Within and/or as part of communication fabric 111, one or more embodiments include processing and/or receiving, using a virtual root complex 154 within PCIe switch 155, various forms of data including, for example, error signals. As used herein, a virtual root complex refers to a stand-alone root complex that resides within a switch (e.g., PCIe switch 155), in contrast to a standard root complex, which has the backing of a computer system and/or connects to a full computer system.

As also depicted in FIG. 1, virtual root complex 154 resides on PCIe switch 155, which fans out to multiple endpoint devices including, e.g., endpoint device-1 (156-1), endpoint device-2 (156-2), and endpoint device-3 (156-3), collectively referred to herein as endpoint devices 156. In one or more embodiments, endpoint devices 156 can include, for example, one or more host adapters, one or more device adapters, one or more field programmable gate arrays (FPGAs), one or more hyperlink adapters, etc., and can be included as part of an input-output (IO) tower. In such an embodiment, an IO tower refers to an external enclosure, apart from the server nodes enclosure(s), which houses one or more adapters and can be connected to the main server enclosure via at least one communication cable.

In at least one embodiment, the data processed by virtual root complex 154 can include a designed set of communications such as, for example, all error signals and/or message signaled interrupts (MSIs) associated with computer 101. More particularly, in one or more embodiments, when one of the endpoint devices 156 detects an error and sends a corresponding error signal (which can include, for example, ERR_FATAL, ERR_NONFATAL, ERR_CORR, downstream port containment (DPC), upstream error containment (UEC), etc.), the error signal is received by a signal handler 157 in the virtual root complex 154. Responsive to processing and/or receiving the error signal, the virtual root complex 154 performs one or more functions including detecting the type of error associated with the error signal. Also, in at least one embodiment, the virtual root complex 154 can, in response to processing and/or receiving the error signal, initiate at least one sequence of actions to perform additional data collection (such as, for example, further detailed below).

By way of further example and/or illustration, if the error signal includes ERR_FATAL and/or ERR_NONFATAL, then the virtual root complex 154 can query the advanced error reporting (AER) capability of the reporting endpoint device 156 for uncorrectable error status and one or more header logs. If the error signal includes ERR_CORR, then the virtual root complex 154 can query the AER capability of the reporting endpoint device 156 for correctable error status and link status. Further, if the error signal includes DPC, then the virtual root complex 154 can query the DPC capability of the reporting endpoint device 156 for additional details on the containment reason(s), and if the error includes UEC, then the requesting bad address will be added to the log by the virtual root complex 154. Such collected details are processed by the virtual root complex 154 and used to generate at least one sequential log which pertains to the communication fabric error(s), from first (received) error signal to last (received) error signal, as well as an accompanying timestamp for each log entry.

The sequential log can be sent by the virtual root complex 154 to one or more nodes (e.g., server nodes) as further detailed below. When the one or more nodes collect the sequential log, the nodes can process at least a portion of the sequential log, for example, to identify the most recent occurrence for use in helping determine if one of the endpoint devices 156 should be reset and/or fenced off in the communication fabric 111.

By way of example, as depicted in FIG. 1, the virtual root complex 154 can generate and send a sequential error signal log to nodes attached to the communication fabric 111, including controlling node 151, managing node 158, and one or more other nodes 152. The sequential log can then be used by at least one of controlling node 151, managing node 158, and one or more other nodes 152 to initiate and/or perform one or more automated actions (e.g., reset one or more of the endpoint devices 156, a fencing action which takes the given resources out of use within the communication fabric 111, etc.). Additionally, for example, a receiver can also have an order of log types to analyze, and if the controlling node 151 itself had a completion timeout, the controlling node 151 may look for completion timeout logs first within the logbook, before examining other error types.

In sending the sequential log to controlling node 151, managing node 158, and one or more other nodes 152, the virtual root complex 154 leverages PCIe switch 155 and non-transparent bridge (NTB) 153, to notify each attached node of the error signals and corresponding temporal information determined as part of generating the sequential log. In one or more embodiments, the communication sent by the virtual root complex 154 to the attached nodes can include the at least one bitmap on which the sequential log has been encoded. The attached nodes can then read the at least one bitmap using an atomic self-clear mechanism, wherein once the read of the at least one bitmap occurs and/or is completed, a second read will indicate a zero status in order to prevent stale signals after acknowledgement. Additionally and/or optionally, in one or more embodiments, the virtual root complex 154 can also send the bitmap to endpoint devices 156.

Also, in at least one embodiment, the attached and/or receiving nodes (e.g., controlling node 151, managing node 158, and/or one or more other nodes 152) can perform virtual masking on the received communication upon a determination that the given node will not be handling an event associated with the communication (e.g., performing an action in response to processing the sequential log). By way of example, in such an embodiment, when the communication fabric 111 is configured, the attached nodes (e.g., controlling node 151, managing node 158, and one or more other nodes 152) can communicate with one another and determine which node should be designated as the owner of the communication fabric 111 and thus have more responsibility on actions performed in the communication fabric 111. Once the ownership of the communication fabric 111 has been determined by communication among nodes, a predetermined mask can be used, indicating which events should be responded to by the owner.

Accordingly, as depicted in FIG. 1, one or more embodiments include a system and techniques related thereto for processing error signal information, generating a sequential log corresponding to such error signal information, and automatically transmitting the sequential log to multiple nodes (e.g., all nodes) attached to a particular fabric (e.g., communication fabric 111). This allows, by way of example, for all nodes within a fabric to be notified of error situations as well as originating and/or isolated fault information related thereto, such that the nodes can start performing one or more respective actions in response to the error(s), as necessary and in a timely manner.

At least one embodiment of the present invention may provide a beneficial effect such as, for example, generating sequentially accurate error signal logs for a communication fabric, and using such logs to detect and/or isolate faults and initiate automated remedial actions efficiently.

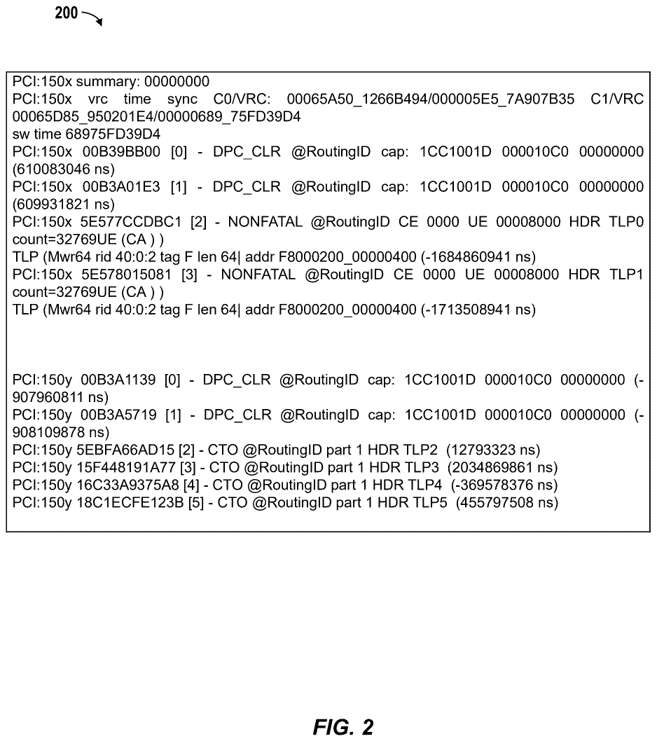

FIG. 2 shows pseudocode for example sequential logs in an illustrative embodiment. In this embodiment, example pseudocode 200 is executed by or under the control of at least one processing system and/or device. For example, the pseudocode 200 may be viewed as comprising a portion of a software implementation of at least part of virtual root complex 154 of the FIG. 1 embodiment.

The pseudocode 200 illustrates two examples of sequential logs, one wherein non-fatal error signals were received, and a second including a string of completion timeouts. In such an example sequential log, a controlling node sends down a corresponding epoch timestamp, in which the virtual root complex (VRC) can create a corresponding timestamp when it receives the epoch timestamp, such that the logbook timestamps can be turned into matching controlling node times.

It is to be appreciated that this particular example pseudocode shows just one example implementation of sample sequential logs, and alternative implementations which include other or alternative content and follows other or alternative rules can be used in other embodiments.

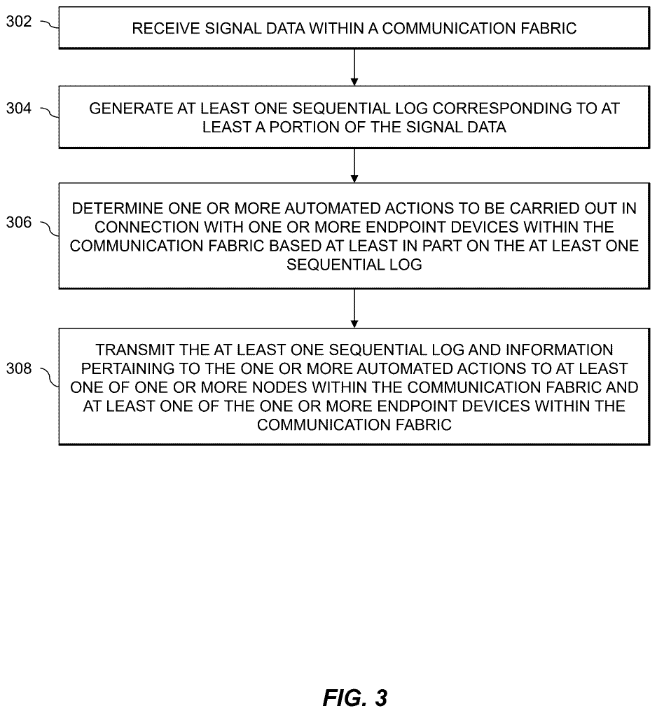

FIG. 3 is a flow diagram illustrating techniques according to an embodiment of the present invention. Step 302 includes receiving signal data within a communication fabric. In at least one embodiment, receiving signal data within a communication fabric includes receiving one or more error signals within the communication fabric. In such an embodiment, receiving one or more error signals can include identifying the one or more error signals as one or more of a fatal error signal, a non-fatal error signal, a correctable error signal, a DPC error signal, and an UEC error signal. Also, receiving signal data can include receiving the signal data, from at least one of the one or more endpoint devices, via at least one virtual root complex implemented in association with at least one PCIe switch in the communication fabric. In such an embodiment, the at least one virtual root complex is linked with the one or more endpoint devices within the communication fabric, and wherein the one or more endpoint devices comprise at least one of one or more host adaptors, one or more device adaptors, one or more FPGAs, and one or more hyperlink adapters.

Step 304 includes generating at least one sequential log corresponding to at least a portion of the signal data. In one or more embodiments, generating at least one sequential log corresponding to at least a portion of the signal data can include querying advanced error reporting capabilities of at least one of the one or more endpoint devices for uncorrectable error status and one or more header logs upon identifying the one or more error signals as one or more of a fatal error signal and a non-fatal error signal. Also, generating at least one sequential log corresponding to at least a portion of the signal data can include querying advanced error reporting capabilities of at least one of the one or more endpoint devices for correctable error status and link status upon identifying the one or more error signals as a correctable error signal. Further, generating at least one sequential log corresponding to at least a portion of the signal data can include querying DPC capabilities of at least one of the one or more endpoint devices for one or more containment reasons upon identifying the one or more error signals as a DPC error signal. Also, generating at least one sequential log corresponding to at least a portion of the signal data can include adding requesting address information to the at least one sequential log upon identifying the one or more error signals as a UEC error signal.

Additionally or alternatively, generating at least one sequential log can include storing the at least a portion of the signal data to the at least one sequential log in conjunction with timestamp data corresponding to receipt of the signal data.

Step 306 includes determining one or more automated actions to be carried out in connection with one or more endpoint devices within the communication fabric based at least in part on the at least one sequential log. In at least one embodiment, determining one or more automated actions to be carried out includes determining that at least one of the one or more endpoint devices is to be one or more of reset and rebooted. Additionally or alternatively, determining one or more automated actions to be carried out can include determining that at least one of the one or more endpoint devices is to be isolated from one or more elements within the communication fabric.

Step 308 includes transmitting the at least one sequential log and information pertaining to the one or more automated actions to at least one of one or more nodes within the communication fabric and at least one of the one or more endpoint devices within the communication fabric.

The techniques depicted in FIG. 3 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 3 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code involved in performing the inventive methods, such as virtual root complex implementation code 426. In addition to virtual root complex implementation code 426, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and virtual root complex implementation code 426, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

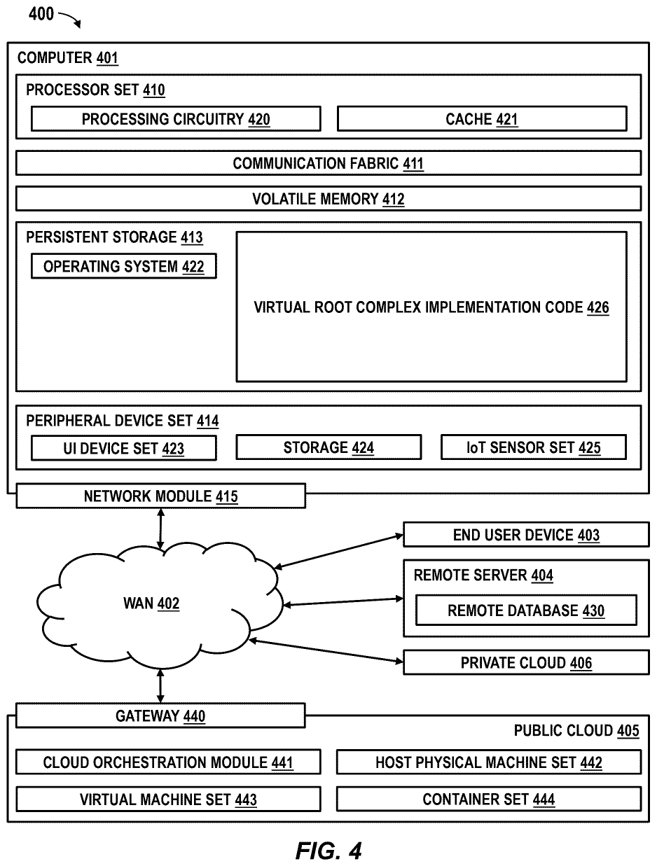

Computer 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

Processor set 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in virtual root complex implementation code 426 in persistent storage 413.

Communication fabric 411 is the signal conduction path that allows the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 412 is any type of volatile memory now known or to be developed in the future. Examples include dynamic type RAM or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

Persistent storage 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a ROM, but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in virtual root complex implementation code 426 typically includes at least some of the computer code involved in performing the inventive methods.

Peripheral device set 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

Network module 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

Remote server 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

Public cloud 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

In computing environment 400, computer 401 is shown as being connected to the internet (see WAN 402). However, in many embodiments of the present invention computer 401 will be isolated from communicating over communications network and not connected to the internet, running as a standalone computer. In these embodiments, network module 415 of computer 401 may not be necessary or even desirable in order to ensure isolation and to prevent external communications coming into computer 401. The standalone computer embodiments are potentially advantageous, at least in some applications of the present invention, because they are typically more secure. In other embodiments, computer 401 is connected to a secure WAN or a secure LAN instead of WAN 402 and/or the internet. In these network connected (that is, not standalone) embodiments, the system designer may want to take appropriate security measures, now known or developed in the future, to reduce the risk that incoming network communications do not cause a security breach.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer system comprising:
a processor set;
one or more computer-readable storage media; and
program instructions stored on the one or more computer-readable storage media to cause the processor set to perform operations comprising:
receiving signal data within a communication fabric;
generating at least one sequential log corresponding to at least a portion of the signal data;
determining one or more automated actions to be carried out in connection with one or more endpoint devices within the communication fabric based at least in part on the at least one sequential log; and
transmitting the at least one sequential log and information pertaining to the one or more automated actions to at least one of one or more nodes within the communication fabric and at least one of the one or more endpoint devices within the communication fabric.

2. The computer system of claim 1, wherein receiving signal data within a communication fabric comprises receiving one or more error signals within the communication fabric.

3. The computer system of claim 2, wherein receiving one or more error signals comprises identifying the one or more error signals as one or more of a fatal error signal, a non-fatal error signal, a correctable error signal, a downstream port containment (DPC) error signal, and an upstream error containment (UEC) error signal.

4. The computer system of claim 3, wherein generating at least one sequential log corresponding to at least a portion of the signal data comprises querying advanced error reporting capabilities of at least one of the one or more endpoint devices for uncorrectable error status and one or more header logs upon identifying the one or more error signals as one or more of a fatal error signal and a non-fatal error signal.

5. The computer system of claim 3, wherein generating at least one sequential log corresponding to at least a portion of the signal data comprises querying advanced error reporting capabilities of at least one of the one or more endpoint devices for correctable error status and link status upon identifying the one or more error signals as a correctable error signal.

6. The computer system of claim 3, wherein generating at least one sequential log corresponding to at least a portion of the signal data comprises querying DPC capabilities of at least one of the one or more endpoint devices for one or more containment reasons upon identifying the one or more error signals as a DPC error signal.

7. The computer system of claim 3, wherein generating at least one sequential log corresponding to at least a portion of the signal data comprises adding requesting address information to the at least one sequential log upon identifying the one or more error signals as a UEC error signal.

8. The computer system of claim 1, wherein receiving signal data comprises receiving the signal data, from at least one of the one or more endpoint devices, via at least one virtual root complex implemented in association with at least one peripheral component interconnect express (PCIe) switch in the communication fabric.

9. The computer system of claim 8, wherein the at least one virtual root complex is linked with the one or more endpoint devices within the communication fabric, and wherein the one or more endpoint devices comprise at least one of one or more host adaptors, one or more device adaptors, one or more field programmable gate arrays (FPGAs), and one or more hyperlink adapters.

10. The computer system of claim 1, wherein generating at least one sequential log comprises storing the at least a portion of the signal data to the at least one sequential log in conjunction with timestamp data corresponding to receipt of the signal data.

11. The computer system of claim 1, wherein determining one or more automated actions to be carried out comprises determining that at least one of the one or more endpoint devices is to be one or more of reset and rebooted.

12. The computer system of claim 1, wherein determining one or more automated actions to be carried out comprises determining that at least one of the one or more endpoint devices is to be isolated from one or more elements within the communication fabric.

13. A computer-implemented method comprising:
receiving signal data within a communication fabric;
generating at least one sequential log corresponding to at least a portion of the signal data;
determining one or more automated actions to be carried out in connection with one or more endpoint devices within the communication fabric based at least in part on the at least one sequential log; and
transmitting the at least one sequential log and information pertaining to the one or more automated actions to at least one of one or more nodes within the communication fabric and at least one of the one or more endpoint devices within the communication fabric;
wherein the method is carried out by at least one computing device.

14. The computer-implemented method of claim 13, wherein receiving signal data within a communication fabric comprises receiving one or more error signals within the communication fabric.

15. The computer-implemented method of claim 13, wherein receiving signal data comprises receiving the signal data, from at least one of the one or more endpoint devices, via at least one virtual root complex implemented in association with at least one PCIe switch in the communication fabric.

16. The computer-implemented method of claim 13, wherein determining one or more automated actions to be carried out comprises determining that at least one of the one or more endpoint devices is to be one or more of reset and rebooted.

17. A computer program product comprising:
one or more computer-readable storage media; and
program instructions stored on the one or more computer-readable storage media to perform operations comprising:
receiving signal data within a communication fabric;
generating at least one sequential log corresponding to at least a portion of the signal data;
determining one or more automated actions to be carried out in connection with one or more endpoint devices within the communication fabric based at least in part on the at least one sequential log; and
transmitting the at least one sequential log and information pertaining to the one or more automated actions to at least one of one or more nodes within the communication fabric and at least one of the one or more endpoint devices within the communication fabric.

18. The computer program product of claim 17, wherein receiving signal data within a communication fabric comprises receiving one or more error signals within the communication fabric.

19. The computer program product of claim 17, wherein receiving signal data comprises receiving the signal data, from at least one of the one or more endpoint devices, via at least one virtual root complex implemented in association with at least one PCIe switch in the communication fabric.

20. The computer program product of claim 17, wherein determining one or more automated actions to be carried out comprises determining that at least one of the one or more endpoint devices is to be one or more of reset and rebooted.
